(19) United States
(12) Patent Application Publication
(10) Pub. No.: US 2011/0037281 A1
(43) Pub. Date: Feb. 17, 2011

(54) TRENCH SHOVEL

(76) Inventor: James E. COX, West Chester, OH (US)

Correspondence Address: Hasse & Nesbitt LLC, 8837 Chapel Square Drive, Suite C, CINCINNATI, OH, 45249, US

(21) Appl. No.: 12/854,531

(22) Filed: Aug. 11, 2010

Related U.S. Application Data
(60) Provisional application No. 61/233,196, filed on Aug. 12, 2009.

(51) Int. Cl. A01B 1/02; A01B 1/00

(52) U.S. Cl. 294/49; 294/60; 294/55

(57) ABSTRACT

A trench shovel with a tempered steel blade having a width narrower than its length, and typically has a rounded or pointed front edge for penetrating into the earth, and a transition portion that has extending there from a tubular member for attachment of a handle of rectilinear cross section. The tubular member extends from the transition portion at an angle selected to provide a pre-selected function for the trench shovel. An angle of about 90 degrees or more allows the shovel to be forced with the toes or ball of the foot in the direction of the front edge, while an angle of about 120-150 degrees allows the shovel to be forced with the toes or ball of the foot in a manner similar of conventional shovels, typically against a pair of toe pegs secured to the rear portion of the tubular member or transition portion of the trench shovel.

### CROSS-REFERENCE TO RELATED APPLICATION

This application claims the benefit of U.S. Provisional Application No. 61/233,196, filed on Aug. 12, 2009, the disclosure of which is incorporated herein by reference.

### FIELD OF THE INVENTION

The invention is in the field of shovels, and in particular trenching shovels.

### BACKGROUND

Water supply lines and drainage lines, including water sprinkling lines, as well as electrical conduit, are buried below ground level, typically sufficiently below the frost line so that buried water lines do not freeze during cold weather.

Trenches can be dug by hand or by a machine known as a trencher. A trencher is a trench digging machine in the form of a powered vehicle arranged to be driven under power along the ground, the vehicle being provided with powered rotating digging apparatus which is rotated under power and is propelled by the vehicle along the ground to dig a trench therein having a length which increases as the vehicle and digging apparatus progress. Examples of trenchers are described in U.S. Pat. Nos. 3,201,948, 3,611,730 and 5,144,760.

Trenches have also been dug by hand, or rock and debris cleaned from a trench dug by machine, using a traditional shovel or a trench shovel. Traditional shovels have a blade width that is significantly wider than needed for burying drainage and water piping, and require the user to remove significantly more earth than necessary. There have been previous attempts to construct a trench shovel, none of which has been completely satisfactory. Examples are those trench shovels disclosed in U.S. Pat. Nos. 4,904,011, 5,520,429, 5,669,649, 5,791,708, D262,686, D272,799, D462,244 and D474,082, the disclosures of which are each incorporated herein by reference in their entirety.

### SUMMARY OF THE INVENTION

The present invention relates to a more functional trench shovel. The blade of the trench shovel is generally clamshell shaped, having a width narrower than its length, and typically has a rounded or pointed front edge for penetrating into the earth, which can often be comprised of shale or tightly compacted soil. The clamshell shape of the blade allows scooping of dirt and debris from the bottom of the trench.

In an aspect of the present invention, a trench shovel includes: a) a tempered steel blade body comprising: a blade having a length along a first axis from a front edge to a rear portion, and two opposed sides that taper to the front edge and that define a width, and having a concave cross section from the rear portion to the front edge, and wherein the length is at least 150% the width; a transition portion extending rearward from the rear portion of the blade; and a tubular member having a cross section and a second axis extending from the transition portion; and b) an elongated handle having an attaching end having a cross section configured for insertion into the tubular member.

In another aspect of the present invention, a trench shovel includes a) a tempered steel blade body comprising: i) a blade having a rear portion and two opposed sides that taper to a front edge, and having a concave cross section from the rear portion to the front edge, the blade oriented along a first axis; ii) a transition portion extending from the rear of the blade; and iii) a tubular member extending from the transition portion, having a cross section and a second axis, wherein the first axis is oriented relative to the second axis at an angle between 90° and 100°; and b) an elongated handle having an attaching end having a cross configured for insertion into the tubular member.

In another aspect of the present invention, a trench shovel includes a) a tempered steel blade body comprising: i) a blade having a rear portion and two opposed sides that taper to a front edge, and having a concave cross section from the rear portion to the front edge, the blade oriented along a first axis; ii) a transition portion extending from the rear of the blade; and iii) a tubular member extending from the transition portion, having a cross section and a second axis, wherein the first axis is oriented relative to the second axis at an angle between 120° and 150°; b) an elongated handle having an attaching end having a cross section configured for insertion into the tubular member; and c) at least one toe peg extending laterally from at least one side of the transition portion.

The handle can be rectangular or square in lateral cross section at its attachment end within the similarly-configured tubular transition portion of the trench shovel. The flat side of the rectangular handle end provides a wider surface area against which the laborer's force is applied to the tubular member of the trench shovel.

To assist in applying foot force and leverage against the back of the trench shovel, to drive the front edge into the earth, the trench shovel includes a toe peg, typically extending laterally from the lateral side the blade body.

The invention also relates to the ornamental shape and design of the trench shovel.

### BRIEF DESCRIPTION OF THE DRAWINGS

FIG. 1 shows the side elevation view of a first embodiment of a trench shovel, having a tempered steel blade and a handle.

FIG. 2 shows the front elevation view of the first embodiment of the trench shovel.

FIG. 3 shows the rear elevation view of the first embodiment of the trench shovel.

FIG. 4 shows the bottom view of the first embodiment of the trench shovel.

FIG. 5 shows the top or plan view of the first embodiment of the trench shovel.

FIG. 6 shows the elevation section view of the first embodiment of the trench shovel through line 6-6 of FIG. 1.

FIG. 7 shows an alternative embodiment of the trench shovel of FIG. 6.

FIG. 8 shows the side elevation view of a second embodiment of a trench shovel, having a tempered steel blade and a handle.

FIG. 9 shows the front elevation view of the second embodiment of the trench shovel.

FIG. 10 shows the rear elevation view of the second embodiment of the trench shovel.

FIG. 11 shows the bottom view of the second embodiment of trench shovel.

FIG. 12 shows the top or plan view of the second embodiment of the trench shovel.

### DETAILED DESCRIPTION OF A PREFERRED EMBODIMENTS OF THE INVENTION

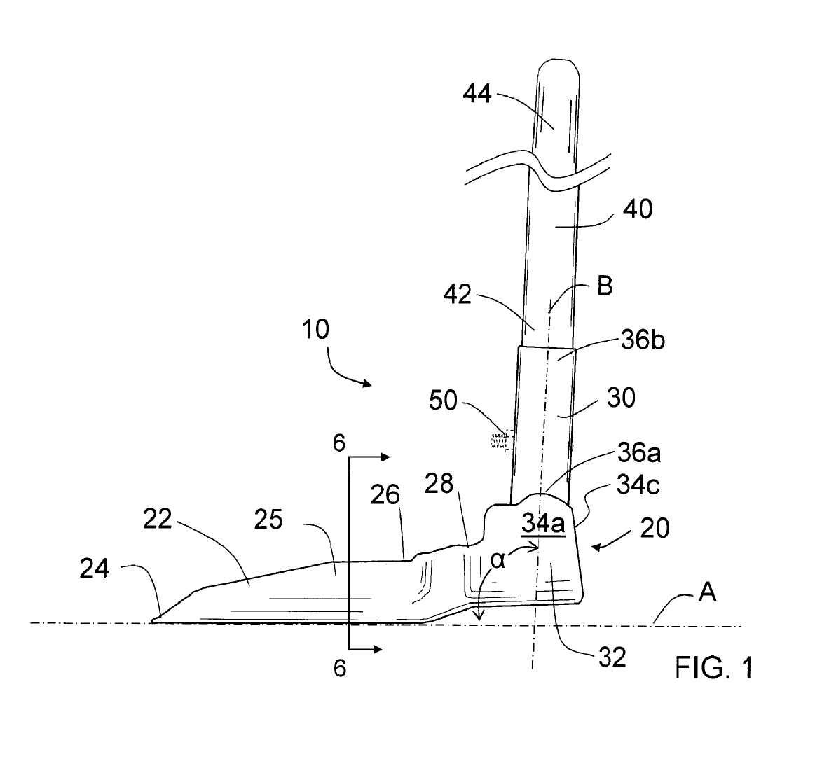

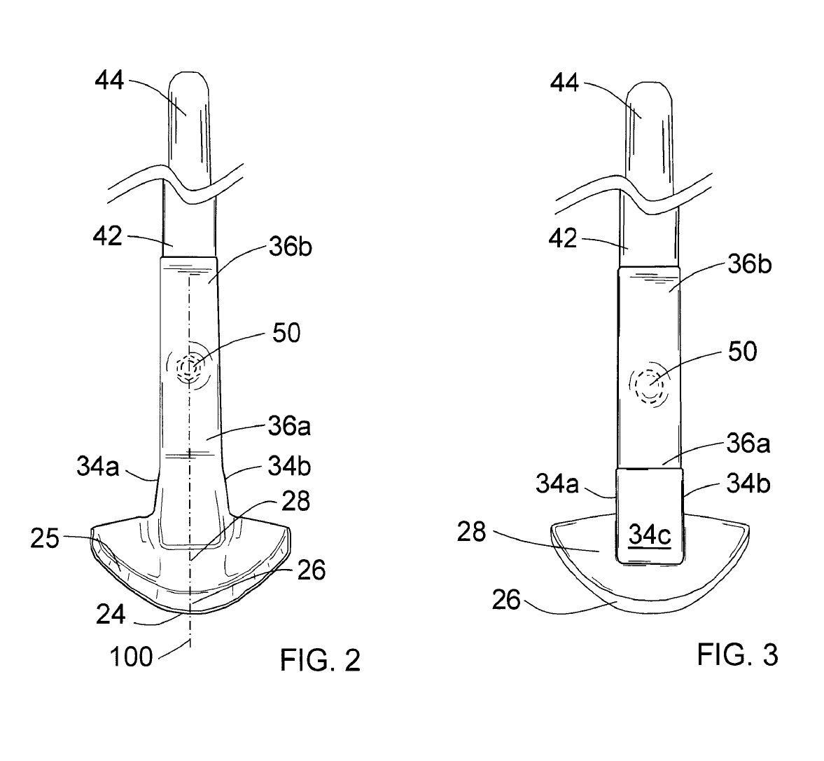

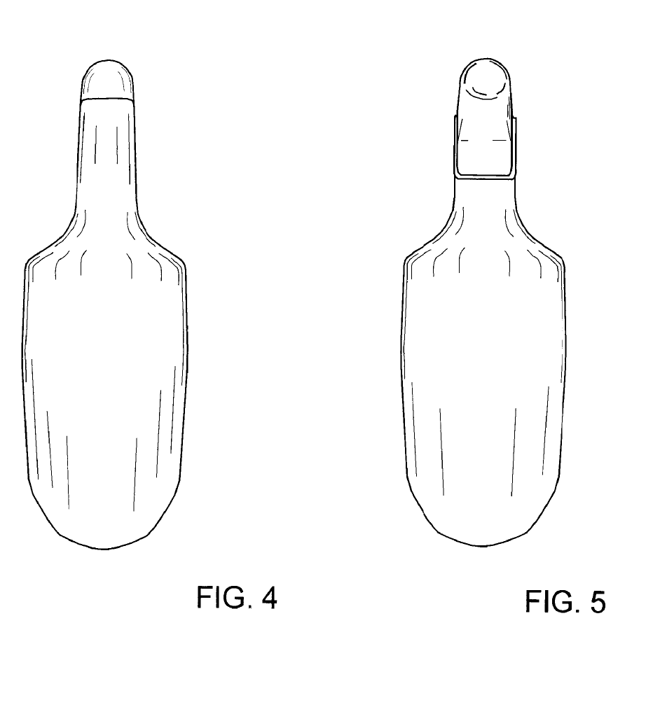

FIGS. 1-6 show a first embodiment of the trench shovel 10 of the present invention, including a blade body 20 and an elongated handle 40. The blade body 20 is made of tempered steel and includes a blade 22 having a length along a first axis A from a front edge 24 to a rear portion 26, and two opposed sides 25 taper to the front edge 24 and that define a width, and having a concave cross section normal to first axis A from the rear portion 26 to the front edge 24. The length is at least 150% the width, and can be at least 200% the width. The concave cross section of the blade is shown having a curved wall 25, which defines an arc of about 90° to about 120°. The blade body 20 also includes a transition portion 28 extending rearward from the rear portion 26 of the blade 22 to a tubular member 30 having a rectilinear lateral cross section and a second axis B. The volume of the concavity of the blade enables removing of dirt from within the trench during use.

The transition portion 28 can be attached securely to, or formed integrally with, the blade 22, and itself transitions from the blade to an elbow portion 32 having opposed lateral sides 34a and 34b, and a rear side 34c connecting the opposed lateral sides 34a and 34b. The front side of the elbow portion can be open, meaning that the opposed lateral sides 34a and 34b are not connected, or can be connected.

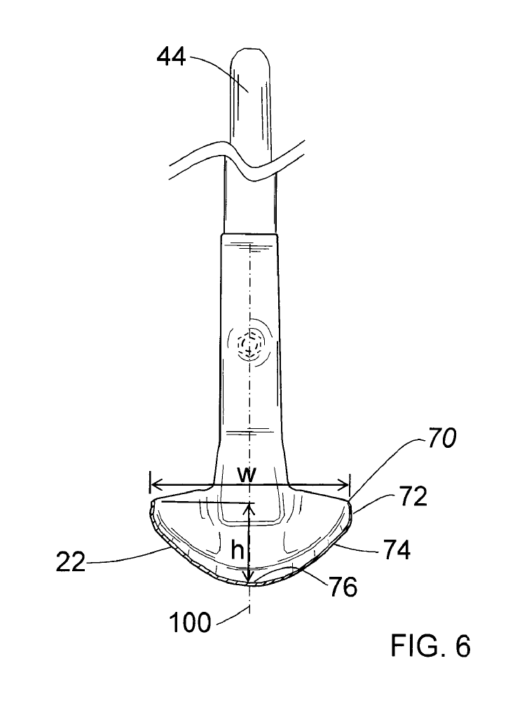

The tubular member 30 has a first end 36a extending from the elbow portion 32, and a second open end 36b, and defines an opening and cavity therein and a second axis B extending through the center of the tubular member 30. In the illustrated embodiment, tubular member 30 has a rectilinear, typically square, cross section, although other shapes can include oval and circular. The sides of the square tubular member are also oriented to face to the opposed transverse sides, the front, and the rear of the blade body. The tubular member 30 can be a separate element that is secured to the elbow 32 of the transition portion 28, such as by welding, or can be formed integral therewith. The tubular member has a sufficient length, and typically at least 10% the length of the handle, to accommodate the same length portion of the handle to provide support for the handle. The tubular member can be a linear tube, or can have a slight elbow or bend 38 therein as shown in FIG. 6 near the first end 36a, for optimizing the leverage of the handle applied to the blade body 20.

A tempered steel blade portion provides the durability and hardness needed to prevent bending or breaking of the blade when striking or penetrating hard shale, rocks and roots in the trench. The steel blades can be tempered by well known means. The blade body consisting of the blade portion and transition portion, out to the elbow, can be obtained from a variety of suppliers. The tempered steel blade portion is available as one of the two confronting and communicating blade members of a post hole digger, such as ones available from Seymour Manufacturing (Seymour, Ind.), and can be the blade part of the Atlas digger, model DG-17.

The elongated handle 40 has an attaching end 42 configured for insertion into the tubular member. The attaching end of the handle is typically configured snuggly into the tubular member without any “play” or gaps there between. The attaching end 40 has a rectilinear, typically square, cross section. Although a rounded attaching end can be used, the strength of the handle end may not withstand the stresses that can be placed on the end by routine use of the tool for trenching. The grasping end 44 is typically cylindrical, with a transition to the rectilinear attaching end 42 along the length there between. One or more securement 50, shown as a bolt and nut, further secure the handle 40 to the tubular member 30, extend through opposed holes in the tubular member and through a registering hole in the attaching end 42. The elongated handle can be made of wood, including hickory, oak, beech, ash, maple, cedar and cherry, as well as fiberglass, plastic and wood-plastic composite materials. A wooden elongated handle is available from Seymour Manufacturing (Seymour, Ind.), and is the handle part of the Atlas digger, model DG-17. The grain of a wooden handle should align with the axis A of the blade.

In this embodiment, the angle α formed by the axes A and B between the blade 22 and the handle 40 is about a right angle, and can be between 80° and 110°, and between 90° and 100°. This relationship enables the user of the trench tool to use the toes of his or her booted foot to push against the elbow portion 32, to drive forward the front edge 24 along the first axes line A. This permits the user to cut and level out the bottom of a trench. The trench shovel 10 in this embodiment can also be used as a pick or ax, to chop into the earth.

FIG. 6 shows a cross-sectional view of the shovel taken through line 6-6 of FIG. 1, through the rearward-most portion of blade 22 of the blade body 20. The blade 22 along each side of its length has an upper wall 72 having upper edge 70 and a middle sidewall 74, joined by a bottom or trough 76. The upper wall 72, middle sidewall 74 and trough 76 are formed integrally and present a curved, cupped or “U” shape that allows the blade along its length to hold a volume of dirt or earth that is being trenched out. The upper edge 70 of the upper wall 72 tapers inwardly toward the centerline 100 and downward toward the trough 76 as they approach the front edge 24 of the blade 22. The ratio of the width “w” between the top edges 70 of the opposed right and left upper walls 72 of the blade 22, to the height “h” from the bottom 76 to a line joining the opposed top edges 70 of the blade 22, is less than about 5:1, and less than about 4:1, and more than 1, more than about 1.5:1, and more than about 2:1, and more than about 2.5, such as about 3:1. A typical width “w” is about 3 inches to 6 inches, such as 3 inches, 4 inches, 5, inches and 6 inches.

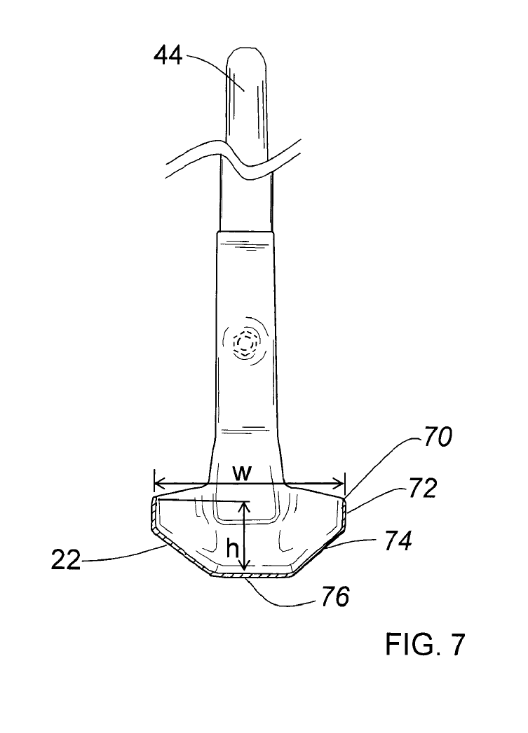

In an alternative embodiment of the blade 22 shown in FIG. 7, the upper walls 72, the middle sidewalls 74 and the bottom wall 76 are more planar, giving the sidewalls a more boxed or beveled appearance.

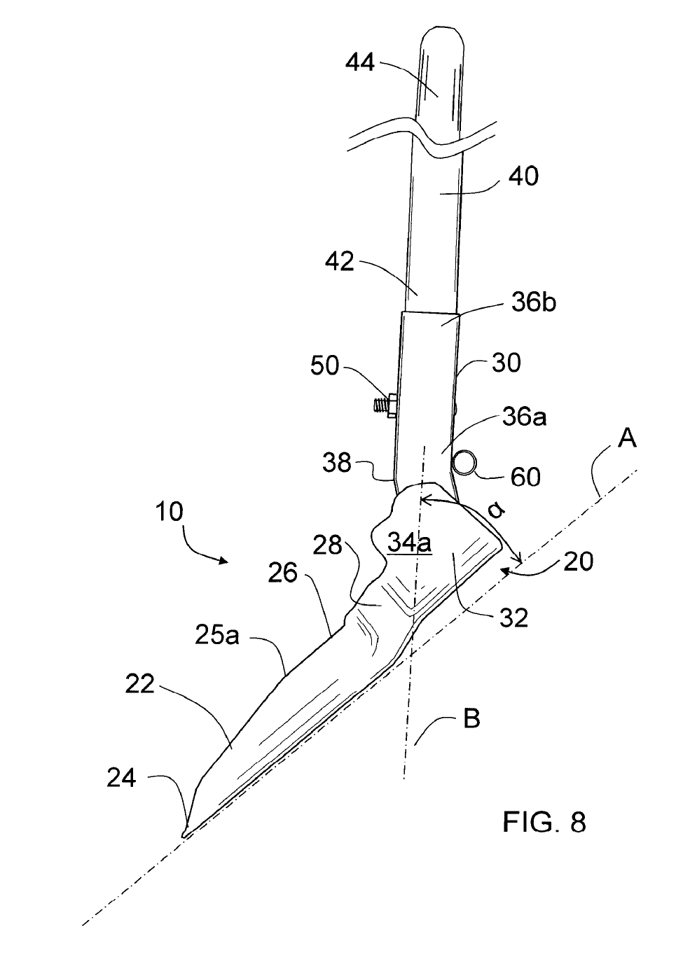

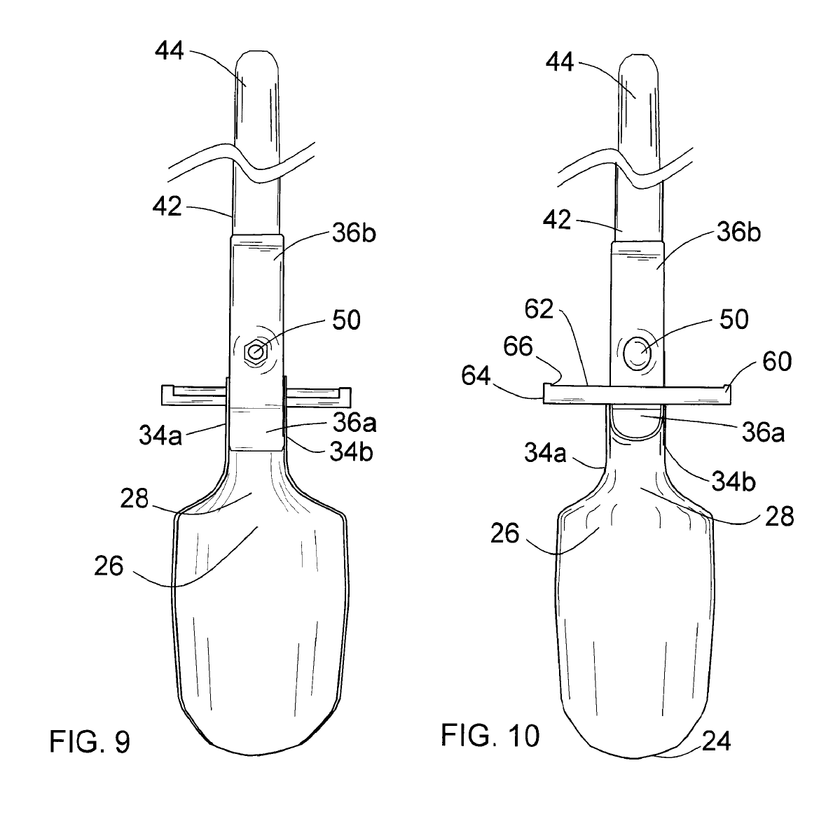

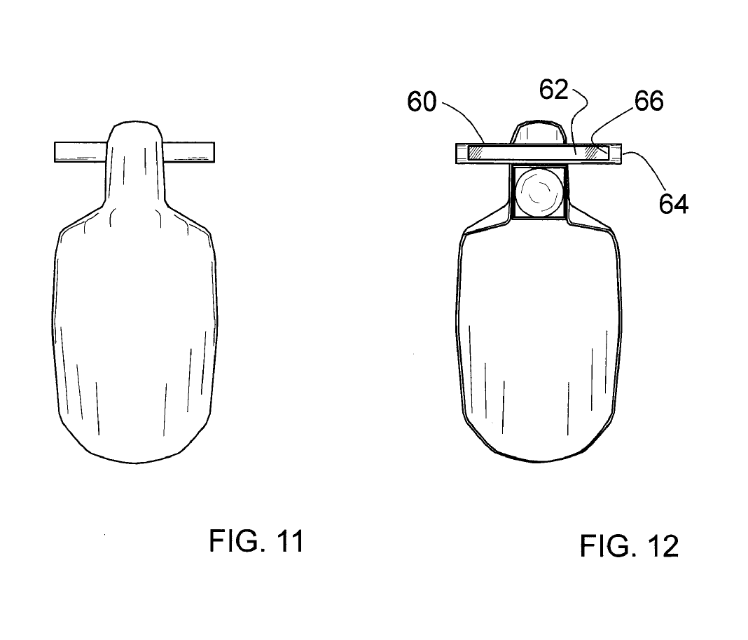

In an alternative embodiment of a trench shovel shown in FIGS. 8-12, the angle α formed by the axes A and B is about 50% larger, and between about 110° and 160°, and between about 120° and 150°. This relationship allows the user to operate the trench shovel more like a conventional shovel, using the foot and the weight of the user to force the front end into the earth.

To assist in applying foot force and leverage against the trench shovel, the trench shovel further includes at least one toe peg 60, typically extending laterally from one lateral side the blade body. As the width of the rear portion of the blade and the transition portion are configured narrowly, it is typically difficult for a user to position the foot securely against the trench shovel for applying force without the foot slipping off of the back or sides of the shovel. The toe peg can be attached to either the transition portion 28 or the tubular member 30. The toe peg can extend from either or both sides of the blade body. The pair of toe pegs extending from both sides can be formed of a single element, or separate elements. The toe peg is typically make of a steel material, and can be any shape that allows the user to exert force against the blade body with the toe or ball of the booted foot. The toe peg can be a rod of about 0.25 inch to 1 inch in diameter and a length extending at least one inch, and up to about 4 inches, and typically about 2 to about 3 inches, from the lateral side of the tubular member 30. In the illustrated embodiment, a pair of toe pegs 60 extending laterally from both lateral sides the blade body, formed from a single cylindrical rod that is attached proximate its midpoint area to the rear-facing side of the tubular member or to the transition portion of the blade body, typically by welding. FIGS. 10 and 12 show the peg(s) 60 with a flat 62 machined inboard of each end 64 of the peg(s) 60, to provide a lip or edge 66 at the end 64 to prevent the sole of the user's boot from slipping off the end of the peg during use. A single flat 62 can extend between the two ends 64 of the single peg, or separate flats 62 can be disposed on each extending peg 60.

In another aspect of the invention, the handle 40 includes a plurality of measuring marks along the length, such as a measuring ruler, with numbers written, printed, labeled or inscribed in the handle to indicate the distance from the front edge 22 of the trench shovel to the measuring marks, to assist the user in estimating the depth of a dug trench.

The trench shovel is useful for digging or cleaning out rock, earth and debris from narrow trenches, such as ones used for below-ground water supply lines, drainage lines, water sprinkling and irrigation lines, and electrical conduit.

While the invention has been disclosed by reference to the details of preferred embodiments of the invention, it is to be understood that the disclosure is intended in an illustrative rather than in a limiting sense, as it is contemplated that modifications will readily occur to those skilled in the art, within the spirit of the invention and the scope of the appended claims.

I claim:

1. A trench shovel comprising:
a) a tempered steel blade body comprising:
i. a blade portion having a length along a first axis from a front edge to a rear portion, and two opposed sides that taper to the front edge and that define a width, and having a concave cross section from the rear portion to the front edge, and wherein the length is at least 150% the width;
ii. a transition portion extending rearward from the rear portion of the blade; and
iii. a tubular member having a cross section and a second axis extending from the transition portion; and
b) an elongated handle having an attaching end having a cross section configured for insertion into the tubular member.

2. The trench shovel of claim 1 wherein the first axis is oriented relative to the second axis at an angle between 120° and 150°.

3. The trench shovel of claim 1 further comprising at least one toe peg extending laterally from one of the opposed lateral sides of the transition portion.

4. The trench shovel of claim 3 wherein the at least one toe peg includes a pair of toe pegs extending laterally from both of the opposed lateral sides the transition portion.

5. The trench shovel of claim 1 wherein the first axis is oriented relative to the second axis at an angle between 80° and 110°.

6. The trench shovel of claim 1 wherein the cross-sectional shape of the tubular member and attaching end of the handle are rectilinear.

7. The trench shovel of claim 1 wherein the handle includes a plurality of measuring marks along the length.

8. The trench shovel of claim 1 wherein the concave cross section of the blade has an arc of about 90°.

9. The trench shovel of claim 1 wherein the handle comprises a plurality of measuring marks along the length.

10. A trench shovel comprising:
a) a tempered steel blade body comprising:
i. a blade having a rear portion and two opposed sides that taper to a front edge, and having a concave cross section from the rear to the front edge, the blade oriented along a first axis;
ii. a transition portion extending from the rear of the blade; and
iii. a tubular member extending from the transition portion, having a cross section and a second axis, wherein the first axis is oriented relative to the second axis at an angle between 120° and 150′;
b) an elongated handle having an attaching end having a cross section configured for insertion into the tubular member; and
c) at least one toe peg extending laterally from at least one side the transition portion or the tubular member.

11. The trench shovel of claim 10 further comprising at least one toe peg extending laterally from both of the opposed lateral sides of the transition portion.

12. The trench shovel of claim 10 wherein the concave cross section of the blade has an arc of about 90° to about 120°.

13. The trench shovel of claim 10 wherein the cross-sectional shape of the tubular member and attaching end of the handle are rectilinear.

14. The trench shovel of claim 10 wherein the toe peg is cylindrical and extends up to 4 inches from the lateral side of the tubular member.

15. The trench shovel of claim 14 wherein the toe peg extends about 2 to about 3 inches.

16. A trench shovel comprising:
a) a tempered steel blade body comprising:
i. a blade portion having a length along a first axis from a front edge to a rear portion, and two opposed sides that taper to the front edge and that define a width, and having a concave cross section from the rear portion to the front edge, and wherein the length is at least 150% the width;
ii. a transition portion extending rearward from the rear portion of the blade; and
iii. a tubular member having a cross section and a second axis extending from the transition portion, wherein the second axis is oriented relative to the first axis at an angle between 80° and 110°; and
b) an elongated handle having an attaching end having a cross section configured for insertion into the tubular member.

17. The trench shovel of claim 16 wherein the cross-sectional shape of the tubular member and attaching end of the handle are rectilinear.

18. The trench shovel of claim 16 wherein the second axis is oriented relative to the first axis at an angle between 90° and 100°
